(19) United States
(12) Patent Application Publication
(10) Pub. No.: US 2024/0023746 A1
(43) Pub. Date: Jan. 25, 2024

(54) COOKING APPLIANCE

(71) Applicant: LG Electronics Inc., Seoul (KR)

(72) Inventors: Hyeunsik NAM, Seoul (KR); Wan Soo KIM, Seoul (KR); Byungkyu PARK, Seoul (KR)

(21) Appl. No.: 18/256,803

(22) PCT Filed: Dec. 9, 2021
(86) PCT No.: PCT/KR2021/018624

§ 371 Date: Jun. 9, 2023

(30) Foreign Application Priority Data
Dec. 10, 2020 (KR) 10-2020-0172718

(51) Int. Cl. A47J 27/088; A47J 45/06; H05B 6/12

(52) U.S. Cl. CPC A47J 27/088; A47J 45/063; H05B 6/12

(57) ABSTRACT

The present specification relates to a cooking appliance and, more specifically, to a cooking appliance comprising a lid and a main body and having an inner pot heated by induction heating. A cooking appliance according to one embodiment of the present specification comprises a lid and a main body. The lid can be completely separated from the main body and is rotation-coupled to the main body. A storage space accommodating at least one electronic device is formed inside the lid. In order to supply power to the electronic device accommodated inside the lid, at least one power transmission coil and at least one power reception coil are arranged at one side of the main body and one side of the lid, respectively. According to one embodiment of the present specification, power can be wirelessly supplied to an electronic device arranged in a storage space inside the lid of a cooking appliance, and the size of an inner pot accommodation space can also be maximized.

### TECHNICAL FIELD

The present specification relates to a cooking appliance, and more particularly, to a cooking appliance including a detachable lid and a main body and having an inner pot heated by induction heating.

### BACKGROUND ART

Generally, a cooking appliance referred to as a rice cooker or cooker is a device for heating food held in an inner container. The inner container is referred to as an inner pot and is accommodated in an inner pot accommodation space formed inside a main body of the cooking appliance. The food held in the inner pot is heated as thermal energy is supplied to the inner pot in a state in which the inner pot is accommodated in the inner pot accommodation space and the inner pot accommodation space is sealed by a lid. In recent years, cooking appliances that supply thermal energy to an inner pot using induction heating have been in wide use.

Patent Document 1 (Japanese Unexamined Patent Application Publication No. 1999-84126) discloses a cooking appliance for heating an inner pot using induction heating. FIG. 1 is a cross-sectional view of the conventional cooking appliance for heating the inner pot using induction heating that is disclosed in Patent Document 1.

Referring to FIG. 1, a cooking appliance 1 according to the related art includes a main body 2 and a lid 10.

A lower surface heating induction coil 6 and a side surface heating induction coil 7, which are for heating an inner pot 8, are each disposed inside a main body 2. Also, a temperature sensor 9 for measuring temperature of the inner pot 8 is disposed on a lower surface of the main body 2.

A handle 11 for lifting the lid 10 is disposed on an upper surface of the lid 10 that is coupled to an upper surface of the main body 2. An inner space of the lid 10 is filled with an insulator 13 for reducing heat loss.

Meanwhile, a lid heating heater 18 and a heating plate 17 are disposed inside the lid 10. An induction coil is disposed in each of the lid 10 and the main body 2 to supply current to the lid heating heater 18. That is, a main body-side upper induction coil 15 connected to a power supply (not illustrated) is disposed inside the main body 2, and, inside the lid 10, a lid-side induction coil 16 is disposed at a position facing the main body-side upper induction coil 15.

By such a structure, when current is supplied to the main body-side upper induction coil 15 through the power supply (not illustrated), a magnetic field is formed by the main body-side upper induction coil 15, and current is induced in the lid-side induction coil 16 due to the magnetic field. The current induced in the lid-side induction coil 16 is supplied to the lid heating heater 18 electrically connected to the lid-side induction coil 16. Accordingly, the lid heating heater 18 and the heating plate 17 are heated.

According to the related art, the main body-side upper induction coil 15 is disposed inside the main body 2 to supply current to the lid heating heater 18. As illustrated in FIG. 1, the main body-side upper induction coil 15 should be disposed at a position facing the lid-side induction coil 16. Therefore, the main body-side upper induction coil 15 is disposed at an upper end inside the main body 2.

However, a space H1 for placing the main body-side upper induction coil 15 should be secured at the upper end inside the main body 2. However, as illustrated in FIG. 1, since the size of the inside of the main body 2 (H1+H2+H1) is limited, there is a problem that the size of the accommodation space in which the inner pot 8 is accommodated (H2) decreases with an increase in the size of the space that the main body-side upper induction coil 15 occupies (H1).

Patent Document 2 (Japanese Unexamined Patent Application Publication No. 2004-313258) discloses another cooking appliance for heating an inner pot using induction heating. FIG. 2 is a cross-sectional view of the conventional cooking appliance for heating the inner pot using induction heating that is disclosed in Patent Document 2.

Referring to FIG. 2, the cooking appliance according to the related art includes a main body 50 and a lid 52 hinge-coupled to the main body 50. A space 54 surrounded by a protective frame 56 is formed inside the main body 50, and an inner pot 53 is accommodated within the protective frame 56. A sensor 59 for detecting temperature of the inner pot 53 is disposed under the inner pot 53.

A heat dissipation plate 26 for sealing the inner pot 53 is disposed under the lid 52. The heat dissipation plate 26 consists of a heat dissipation plate main body 26a and a ring-shaped heating body 26b, which are made of metal. The ring-shaped heating body 26b is induction-heated by an induction heating (IH) coil 29a disposed in a coil accommodating portion 30b inside the space 54 of the main body 50.

As illustrated in FIG. 2, a space for placing the coil accommodating portion 30b and the IH coil 29a (H1) should be secured at an upper end of the space 54 of the main body 50 of the conventional cooking appliance. However, in FIG. 2, since the size of the inside of the main body 50 (H1+H2+H1) is limited, there is a problem that the size of the accommodation space accommodating the inner pot 53 (H2) decreases with an increase in the size of the space occupied by the coil accommodating portion 30b and the IH coil 29a (H1).

Patent Document 3 (Japanese Unexamined Patent Application Publication No. 1994-133856) discloses a pressure cooker including a timer. FIG. 3 is a cross-sectional view of the pressure cooker disclosed in Patent Document 3.

Referring to FIG. 3, a pressure cooker 70 includes a main body 72 configured to hold cooking ingredients and a lid 73 configured to seal an opening of the main body 72 and leak internal pressure to the outside. A locking valve 71 and a timer 74 are disposed at an upper portion of the lid 73. The timer 74 includes a display configured to display a cooking time and a speaker configured to output a voice or signal.

In FIG. 3, a main body handle 77 is disposed at one side of the main body 72, and a lid handle 78 is disposed at one side of the lid 73. During cooking using the pressure cooker 70, when the main body handle 77 and the lid handle 78 are disposed to overlap each other, the opening of the main body 72 is sealed by the lid 73.

In Patent Document 3, the timer 74 driven by power supplied thereto is disposed on the lid 73. However, Patent Document 3 does not disclose a specific power supply means for supplying power. Also, in Patent Document 3, since an inner pot accommodation space accommodating an inner pot and a component for supplying power to the lid 73 are not present in the main body 72, the size of the inside of the main body 72 is not limited by other components.

Meanwhile, Patent Document 4 (Korean Unexamined Patent Application Publication No. 10-2020-0101825) discloses a wireless induction heating rice cooker. A power transmission coil 150 and a power reception coil 140b, which are devices for supplying power to an electronic device disposed in a lid 120 are each disclosed in FIGS. 2 and 3 of Patent Document 4. However, in Patent Document 4, a problem due to a limitation in an inner pot accommodation space that is caused by the arrangement of the power transmission coil 150 and the power reception coil 140b and a means for addressing such a problem are not disclosed.

### DISCLOSURE

### Technical Problem

The present specification is directed to providing a cooking appliance capable of maximizing the size of an inner pot accommodation space while enabling power to be wirelessly supplied to an electronic device disposed in a storage space inside a lid.

Also, the present specification is directed to providing a cooking appliance allowing a user to easily check a fastening state between a lid and a main body.

Also, the present specification is directed to providing a cooking appliance allowing a fastening state between a lid and a main body to be detected without a separate part, thereby reducing the manufacturing cost and size.

Also, the present specification is directed to providing a cooking appliance in which components for power supply, such as a plug or a cable, are not provided on an outer surface of a main body, which makes it convenient to move and store the cooking appliance.

Also, the present specification is directed to providing a cooking appliance allowing a lid to be completely detached from a main body, which makes it convenient to clean or manage the cooking appliance and enables a more sanitary use.

Also, the present specification is directed to providing a cooking appliance capable of increasing the size of an inner pot accommodation space formed inside a main body while not increasing the size of a lower surface of the main body that comes in contact with an induction heating device.

Also, the present specification is directed to providing a cooking appliance that is resistant to contamination and convenient to clean.

Also, the present specification is directed to providing a cooking appliance that is convenient to move or be stored in a storage space by a user.

Also, the present specification is directed to providing a cooking appliance that can be used non-directionally on an induction heating device.

In addition, the present specification is directed to providing a cooking appliance capable of transmitting power to electronic devices, which are disposed inside a lid, while maintaining a compact size to facilitate movement or storage.

Objectives of the present specification are not limited to the above-mentioned objectives, and other unmentioned objectives of the present specification and advantages thereof should be more clearly understood from embodiments of the present specification described below. Also, it should be easily understood that the objectives and advantages of the present specification may be realized by components described in the claims below and combinations thereof.

### Technical Solution

One embodiment of the present specification provides a cooking appliance including a main body in which an inner pot accommodation space is formed, an inner pot accommodated in the inner pot accommodation space, a lid coupled to one surface of the main body to seal the inner pot accommodation space and having a storage space formed therein to accommodate one or more electronic devices, a power transmission coil disposed inside a main body handle formed at one side of the main body and configured to receive power transferred from an outside, and a power reception coil disposed inside a lid handle formed at one side of the lid and configured to receive power transmitted by the power transmission coil.

In one embodiment of the present specification, the one or more electronic devices may be driven by the power received by the power reception coil.

In one embodiment of the present specification, the lid may be rotatably coupled to the main body. Also, in a state in which the lid is coupled to the one surface of the main body to seal the inner pot accommodation space, the main body handle may completely overlap the lid handle.

In one embodiment of the present specification, the lid may be a detachable lid that is completely detachable from the main body.

In one embodiment of the present specification, the main body handle and the lid handle may be made of a nonmetallic material.

In one embodiment of the present specification, the main body handle may protrude in a radial direction from the one side of the main body. Also, the lid handle may protrude in a radial direction from the one side of the lid.

In one embodiment of the present specification, a magnitude of power transferred to the one or more electronic devices may be proportional to an area where the power transmission coil and the power reception coil overlap.

In one embodiment of the present specification, a power conversion device configured to convert alternating current power supplied by the power reception coil into direct current power may be disposed in the storage space.

In one embodiment of the present specification, a controller configured to determine a fastening state between the lid and the main body may be disposed in the storage space.

In one embodiment of the present specification, the controller may determine the fastening state between the lid and the main body by comparing a magnitude of current, a magnitude of voltage, or a magnitude of power supplied to the one or more electronic devices by the power reception coil with a predetermined reference value.

In one embodiment of the present specification, the controller may determine that the fastening state between the lid and the main body is normal in a case in which the magnitude of current, the magnitude of voltage, or the magnitude of power is the reference value or more and may determine that the fastening state between the lid and the main body is abnormal in a case in which the magnitude of current, the magnitude of voltage, or the magnitude of power is less than the reference value.

In one embodiment of the present specification, the controller may display information on the fastening state between the lid and the main body through a display module or may send the information on the fastening state between the lid and the main body to another device through a communication module.

In one embodiment of the present specification, the cooking appliance may further include a heating coil disposed inside the main body. Also, the inner pot may be heated by the heating coil.

In one embodiment of the present specification, the cooking appliance may further include a power transfer coil disposed inside the main body and configured to transfer power transmitted from an outside to the power transmission coil.

In one embodiment of the present specification, the inner pot may be heated by the power transfer coil.

In one embodiment of the present specification, a transverse cross-section of the main body and a transverse cross-section of the lid may have a circular shape.

Also, another embodiment of the present specification provides a cooking appliance including a main body in which an inner pot accommodation space is formed, an inner pot accommodated in the inner pot accommodation space, a lid coupled to one surface of the main body to seal the inner pot accommodation space and having a storage space formed therein to accommodate one or more electronic devices, a power transmission coil disposed at a position protruding in a radial direction from one side of the main body and configured to receive power transferred from an outside, and a power reception coil disposed at a position protruding in a radial direction from one side of the lid and configured to receive power transmitted by the power transmission coil.

In one embodiment of the present specification, the one or more electronic devices may be driven by the power received by the power reception coil.

In one embodiment of the present specification, the lid may be rotatably coupled to the main body. Also, in a state in which the lid is coupled to the one surface of the main body to seal the inner pot accommodation space, the power transmission coil and the power reception coil may completely overlap each other.

In one embodiment of the present specification, the lid may be a detachable lid that is completely detachable from the main body.

In one embodiment of the present specification, the power transmission coil may be disposed inside a main body handle formed at one side of the main body. Also, the power reception coil may be disposed inside a lid handle formed at one side of the lid.

In one embodiment of the present specification, the main body handle and the lid handle may be made of a nonmetallic material.

In one embodiment of the present specification, a magnitude of power transferred to the one or more electronic devices may be proportional to an area where the power transmission coil and the power reception coil overlap.

In one embodiment of the present specification, a power conversion device configured to convert alternating current power supplied by the power reception coil into direct current power may be disposed in the storage space.

In one embodiment of the present specification, a controller configured to determine a fastening state between the lid and the main body may be disposed in the storage space.

In one embodiment of the present specification, the controller may determine the fastening state between the lid and the main body by comparing a magnitude of current, a magnitude of voltage, or a magnitude of power supplied to the one or more electronic devices by the power reception coil with a predetermined reference value.

In one embodiment of the present specification, the controller may determine that the fastening state between the lid and the main body is normal in a case in which the magnitude of current, the magnitude of voltage, or the magnitude of power is the reference value or more and may determine that the fastening state between the lid and the main body is abnormal in a case in which the magnitude of current, the magnitude of voltage, or the magnitude of power is less than the reference value.

In one embodiment of the present specification, the controller may display information on the fastening state between the lid and the main body through a display module or may send the information on the fastening state between the lid and the main body to another device through a communication module.

In one embodiment of the present specification, the cooking appliance may further include a heating coil disposed inside the main body. Also, the inner pot may be heated by the heating coil.

In one embodiment of the present specification, the cooking appliance may further include a power transfer coil disposed inside the main body and configured to transfer power transmitted from an outside to the power transmission coil.

In one embodiment of the present specification, the inner pot may be heated by the power transfer coil.

In one embodiment of the present specification, a transverse cross-section of the main body and a transverse cross-section of the lid may have a circular shape.

Also, another embodiment of the present specification provides a cooking appliance including a main body in which an inner pot accommodation space is formed, an inner pot accommodated in the inner pot accommodation space, a lid coupled to one surface of the main body to seal the inner pot accommodation space and having a storage space formed therein to accommodate one or more electronic devices, a power transmission coil disposed at one side of the main body and configured to receive power transferred from an outside, and a power reception coil disposed at one side of the lid and configured to receive power transmitted by the power transmission coil.

In one embodiment of the present specification, the inner pot may be heated by power received by a power transfer coil. Also, the one or more electronic devices may be driven by the power received by the power reception coil.

In one embodiment of the present specification, a distance between a center of a lower surface of the main body and a center of the power transmission coil may be greater than a radius of the lower surface of the main body. Also, a distance between the center of the lower surface of the main body and a center of the power reception coil may be greater than the radius of the lower surface of the main body.

In one embodiment of the present specification, the lid may be rotatably coupled to the main body. Also, in a state in which the lid is coupled to the one surface of the main body to seal the inner pot accommodation space, the power transmission coil and the power reception coil may completely overlap each other.

In one embodiment of the present specification, the lid may be a detachable lid that is completely detachable from the main body.

In one embodiment of the present specification, the power transmission coil may be disposed inside a main body handle protruding in a radial direction from the one side of the main body. Also, the power reception coil may be disposed inside a lid handle protruding in a radial direction from the one side of the lid.

In one embodiment of the present specification, the main body handle and the lid handle may be made of a nonmetallic material.

In one embodiment of the present specification, a magnitude of power transferred to the one or more electronic devices may be proportional to an area where the power transmission coil and the power reception coil overlap.

In one embodiment of the present specification, a power conversion device configured to convert alternating current power supplied by the power reception coil into direct current power may be disposed in the storage space.

In one embodiment of the present specification, a controller configured to determine a fastening state between the lid and the main body may be disposed in the storage space.

In one embodiment of the present specification, the controller may determine the fastening state between the lid and the main body by comparing a magnitude of current, a magnitude of voltage, or a magnitude of power supplied to the one or more electronic devices by the power reception coil with a predetermined reference value.

In one embodiment of the present specification, the controller may determine that the fastening state between the lid and the main body is normal in a case in which the magnitude of current, the magnitude of voltage, or the magnitude of power is the reference value or more and may determine that the fastening state between the lid and the main body is abnormal in a case in which the magnitude of current, the magnitude of voltage, or the magnitude of power is less than the reference value.

In one embodiment of the present specification, the controller may display information on the fastening state between the lid and the main body through a display module or may send the information on the fastening state between the lid and the main body to another device through a communication module.

In one embodiment of the present specification, the cooking appliance may further include a heating coil disposed inside the main body. Also, the inner pot may be heated by the heating coil.

In one embodiment of the present specification, the cooking appliance may further include a power transfer coil disposed inside the main body and configured to transfer power transmitted from an outside to the power transmission coil.

In one embodiment of the present specification, the inner pot may be heated by the power transfer coil.

In one embodiment of the present specification, a transverse cross-section of the main body and a transverse cross-section of the lid may have a circular shape.

### Advantageous Effects

According to one embodiment of the present specification, power can be wirelessly supplied to an electronic device disposed in a storage space inside a lid of a cooking appliance using a power reception coil disposed at a lid handle and a power transmission coil disposed at a main body handle.

Also, according to one embodiment of the present specification, components necessary to wirelessly supply power to the electronic device disposed in the storage space inside the lid are not disposed in an inner space of a main body. Therefore, the size of an inner pot accommodation space is increased as compared to the related art even without increasing the overall size of the cooking appliance.

Also, according to one embodiment of the present specification, while the power is wirelessly transmitted to the electronic device disposed in the storage space inside the lid of the cooking appliance using the power reception coil disposed at the lid handle and the power transmission coil disposed at the main body handle, a fastening state between the lid and the main body is quickly identified, and the identified fastening state between the lid and the main body is immediately displayed on the cooking appliance or an induction heating device. Accordingly, a situation in which a user attempts cooking in a state in which the inner pot accommodation space of the main body is not completely sealed by the lid can be prevented. Also, the user can easily and intuitively identify the fastening state between the lid and the main body of the cooking appliance.

Also, according to one embodiment of the present specification, the fastening state between the lid and the main body is identified only based on power transferred to the inside of the lid through the power transmission coil and the power reception coil without a separate part for detecting the fastening state between the lid and the main body. Therefore, the manufacturing cost and size of the cooking appliance can be reduced.

Also, the cooking appliance according to one embodiment of the present specification is driven by a wireless power supply method in which the cooking appliance wirelessly receives power from the induction heating device, instead of a wired power supply method in which the cooking appliance receives power by a plug connected to a cable being plugged into a plug socket. Accordingly, a cable or plug provided outside a main body of a conventional cooking appliance is not provided in the cooking appliance according to one embodiment of the present specification. Therefore, the user can freely move the cooking appliance and conveniently store the cooking appliance.

Also, in one embodiment of the present specification, the lid of the cooking appliance is completely detached from the main body. Therefore, cleaning of the lid becomes more convenient, and the lid can be cleaned and managed to be cleaner. Also, since the lid is completely detached from the main body, cleaning of the main body also becomes convenient. In this way, since the main body and the lid can each be cleaned conveniently, the cooking appliance can be more sanitarily used.

Also, in one embodiment of the present specification, the cooking appliance can wirelessly receive power from the induction heating device, and the size of the induction heating device and the size of a heating area formed on the induction heating device are limited. Therefore, the size of a lower surface of the cooking appliance that comes in contact with the heating area of the induction heating device is also inevitably limited. According to one embodiment of the present specification, since the size of the inner pot accommodation space formed inside the main body can be increased while not increasing the size of the lower surface of the main body that comes in contact with the induction heating device, a cooking capacity of the cooking appliance is increased as compared to the related art.

Also, in one embodiment of the present specification, an outer surface of the main body of the cooking appliance can be made of a metal material. Also, an upper surface of the lid that is completely detached from the main body can also be made of a metal material. Accordingly, the cooking appliance becomes resistant to contamination, and the user can conveniently clean the cooking appliance.

Meanwhile, the cooking appliance according to the related art receives power via a wire through a cable connected to a plug socket and thus is placed at a fixed position without being stored in a storage space and is not frequently moved by the user. However, the cooking appliance according to one embodiment of the present specification can wirelessly receive power through the induction heating device. Therefore, the user can withdraw the cooking appliance from the storage space and place the cooking appliance on the induction heating device during cooking and can store the cooking appliance in the storage space once cooking is completed. According to one embodiment of the present specification, since the user can easily lift the main body or the lid using the main body handle and the lid handle, the user can conveniently move the cooking appliance and store the cooking appliance.

Also, when the cooking appliance according to one embodiment of the present specification receives power from the induction heating device, power is supplied to the inside of the cooking appliance through the lower surface of the main body that comes in contact with the induction heating device. Therefore, the shape of the lower surface of the main body being circular is beneficial for the power to be evenly transferred to the inside of the cooking appliance. Also, since the lower surface of the main body is formed in a circular shape, when the cooking appliance is placed on the induction heating device, power can be evenly transferred to the inside of the cooking appliance regardless of a direction in which the cooking appliance faces. According to one embodiment of the present specification, since the lower surface of the cooking appliance is formed in a circular shape, the cooking appliance can be used non-directionally on the induction heating device.

Meanwhile, since the cooking appliance according to one embodiment of the present specification receives power from the induction heating device, the size of the cooking appliance is limited according to the size of the induction heating device and the size of the heating area. Also, due to being frequently moved and stored unlike the conventional cooking appliance, the cooking appliance according to one embodiment of the present specification has a compact size to allow the user to easily move and store the cooking appliance. Thus, the size of the cooking appliance is limited to a predetermined size or smaller. In a case in which the size of the cooking appliance is not limited, by making the size of the main body very large, a coil for supplying power to the electronic devices inside the lid may be disposed inside the main body, and the size of the inner pot accommodation space may also be increased. However, due to the reasons described above, there is a problem that the size of the inner pot accommodation space is relatively reduced when the coil for supplying power to the electronic devices inside the lid is disposed inside the main body in a state in which the size of the cooking appliance is limited to a predetermined size or less. In one embodiment of the present specification, since the coil for supplying power to the electronic devices inside the lid is not disposed in the inner space of the main body, the size of the inner pot accommodation space and the size of the inner pot are not affected by the coil for supplying power to the electronic devices inside the lid. In other words, according to one embodiment of the present specification, in a state in which the overall size of the cooking appliance is limited to a predetermined size or less, the size of the inner pot accommodation space and the size of the inner pot can be increased as compared to the related art while power is wirelessly supplied to the electronic devices inside the lid.

### DESCRIPTION OF DRAWINGS

FIG. 1 is a cross-sectional view of a conventional cooking appliance for heating an inner pot using induction heating that is disclosed in Patent Document 1.

FIG. 2 is a cross-sectional view of a conventional cooking appliance for heating an inner pot using induction heating that is disclosed in Patent Document 2.

FIG. 3 is a cross-sectional view of a pressure cooker disclosed in Patent Document 3.

FIG. 4 is a perspective view illustrating a state in which a lid, an inner pot, and a main body of a cooking appliance according to one embodiment of the present specification are separated.

FIG. 5 is a cross-sectional view illustrating a state in which the lid, inner pot, and main body of the cooking appliance according to one embodiment of the present specification are coupled.

FIG. 6 is a cross-sectional view illustrating a state in which a lid, an inner pot, and a main body of a cooking appliance according to another embodiment of the present specification are coupled.

FIG. 7 illustrates an embodiment in which a wireless transmission coil disposed inside a main body handle and a wireless reception coil disposed inside a lid handle are each disposed in multiple layers.

FIG. 8 is a cross-sectional view illustrating a state in which a lid, an inner pot, and a main body of a cooking appliance according to still another embodiment of the present specification are coupled.

FIG. 9 is a cross-sectional view illustrating a state in which a lid, an inner pot, and a main body of a cooking appliance according to yet another embodiment of the present specification are coupled.

FIG. 10 is a cross-sectional view illustrating a state in which a lid, an inner pot, and a main body of a cooking appliance according to yet another embodiment of the present specification are coupled.

FIG. 11 illustrates a case in which a fastening state between a lid and a main body of a cooking appliance placed on an induction heating device is abnormal in one embodiment of the present specification.

FIG. 12 illustrates a case in which the fastening state between the lid and the main body of the cooking appliance placed on the induction heating device is normal in one embodiment of the present specification.

### MODES OF THE INVENTION

The objectives, features, and advantages will be described in detail below with reference to the accompanying drawings, and accordingly, those of ordinary skill in the art to which the present specification pertains should be able to easily practice the technical idea of the present specification. In describing embodiments of the present specification, when it is determined that detailed description of a known art may unnecessarily obscure the gist of the present specification, the detailed description thereof will be omitted. Hereinafter, exemplary embodiments according to the present specification will be described in detail with reference to the accompanying drawings. In the drawings, the same reference numerals are used to indicate the same or similar components.

Hereinafter, when an arbitrary configuration is described as being disposed on an “upper portion (or lower portion)” of a component or being disposed “on (or under)” the component, this may not only mean that the arbitrary configuration is disposed in contact with an upper surface (or lower surface) of the component but may also mean that another configuration may be interposed between the component and the arbitrary configuration disposed on (or under) the component.

Also, when a certain component is described as being “connected,” “coupled,” or “linked” to another component, this may mean that the component is directly connected or linked to the other component but may also mean that the component is “connected,” “coupled,” or “linked” to the other component via another component “interposed” therebetween or the component and the other component are “connected,” “coupled,” or “linked” through other components.

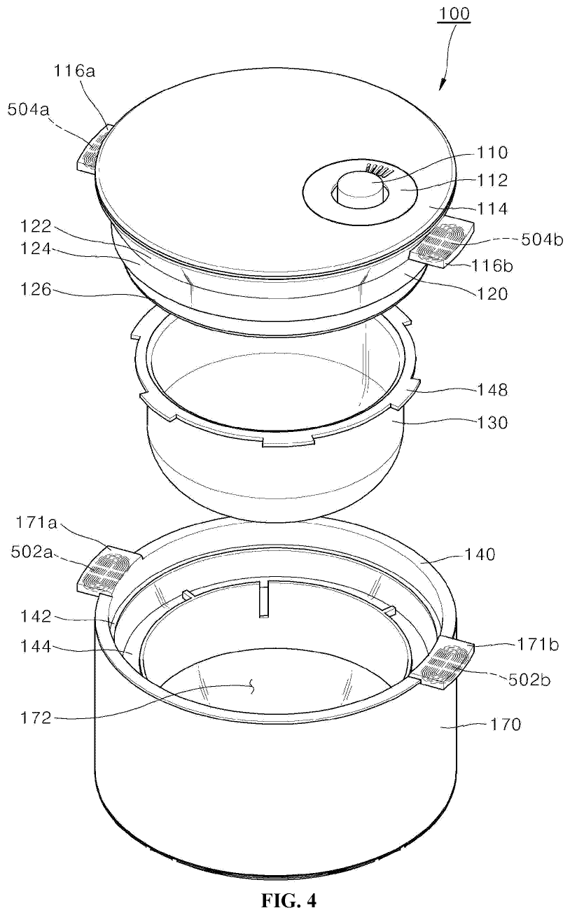

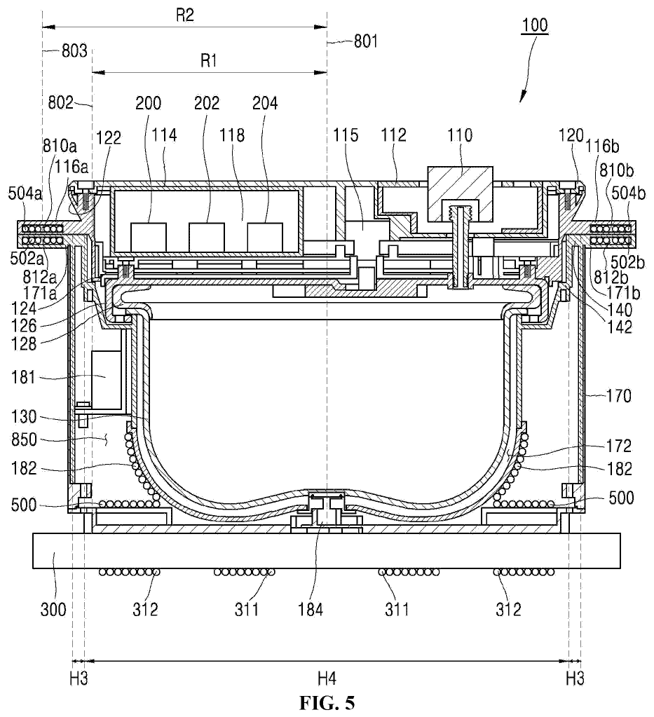

FIG. 4 is a perspective view illustrating a state in which a lid, an inner pot, and a main body of a cooking appliance according to one embodiment of the present specification are separated. Also, FIG. 5 is a cross-sectional view illustrating a state in which the lid, inner pot, and main body of the cooking appliance according to one embodiment of the present specification are coupled.

Referring to the drawings, a cooking appliance 100 according to one embodiment of the present specification includes a lid 120, an inner pot 130, and a main body 170.

The lid 120 is coupled to the main body 170 and seals an inner pot accommodation space 172 formed inside the main body 170. Therefore, the lid 120 has a shape that corresponds to the inner pot accommodation space 172 of the main body 170. For example, a transverse cross-section of the lid 120 has a circular shape in the embodiment of FIG. 4, but the shape of the lid 120 may vary according to embodiments.

As illustrated in the drawings, the lid 120 according to one embodiment of the present specification is a detachable lid. That is, the lid 120 according to one embodiment of the present specification is not hinge-coupled to the main body 170 and is completely detachable from the main body 170. In this way, when the lid 120 is completely detached from the main body 170, it becomes easy to move, clean, or repair each of the lid 120 and the main body 170.

A pressure weight 110 is disposed on an upper surface of the lid 120. The pressure weight 110 serves to maintain pressure inside the inner pot 130 constant when food held in the inner pot 130 is cooked in a state in which the lid 120 is coupled to the main body 170 and the inner pot accommodation space 172 is sealed. For example, when the pressure inside the inner pot 130 becomes higher than a predetermined pressure, the pressure weight 110 may move upward due to steam inside the inner pot 130, and some steam may be discharged.

Also, a soundproof cap 112 having a sound absorbing member embedded therein to reduce noise generated when steam is discharged by the pressure weight 110 is disposed around the pressure weight 110.

Also, the lid 120 includes a lid cover 114. As illustrated in FIG. 5, a lid storage space 118 is formed under the lid cover 114. Electronic devices such as a controller 200, a communication module 204, and a display module 204 are accommodated in the lid storage space 118. Also, a solenoid valve 115 configured to control pressure inside the main body 170 is disposed under the lid cover 114. The lid cover 114 is coupled to an upper portion of the lid storage space 118 to seal the lid storage space 118.

In one embodiment of the present specification, the lid cover 114 may be made of a metal material. When the lid cover 114 is made of a metal material, it becomes convenient to clean foreign matter on the lid cover 114, and a phenomenon in which the lid cover 114 is contaminated or discolored due to other substances in the cleaning or cooking process can be prevented.

Also, when the lid cover 114 is made of a metal material, impact or vibration applied from the outside is reduced such that the components inside the lid 120 are more safely protected, and deformation of the lid 120 due to external impact, vibration, or temperature is prevented such that the durability of the cooking appliance 100 is improved.

Also, due to the lid cover 114 being made of a metal material, an aesthetic sense of the cooking appliance 100 is enhanced. In particular, when the lid cover 114 and an outer surface of the main body 170 are made of the same metal material as described below, a sense of unity is formed between the lid 120 and the main body 170 when the lid 120 and the main body 170 are coupled, and thus the overall aesthetic sense of the cooking appliance 100 is enhanced.

Meanwhile, the cooking appliance 100 according to one embodiment of the present specification wirelessly receives power from an induction heating device. Therefore, in order to not affect the wireless power transmission from the induction heating device, the lid cover 114 may be made of a metal material in which an eddy current is not easily induced by a magnetic field. For example, the lid cover 114 may not include a magnetic material or may be made of a nonmagnetic metal material with very low magnetism.

The controller 200 is a device configured to control driving of the cooking appliance 100. The controller 200 may, according to a user command or a driving state of the cooking appliance 100, control a heating operation of the cooking appliance 100 or control driving of the communication module 204 and the display module 204 which will be described below.

In one embodiment of the present specification, the controller 200 may determine a fastening state between the lid 120 and the main body 170 and may, according to a result of determination, control driving of the cooking appliance 100.

In one embodiment of the present specification, power is supplied to the electronic devices disposed inside the lid storage space 118 by power reception coils 504a and 504b disposed inside lid handles 116a and 116b which will be described below. The controller 200 may compare the magnitude of current, the magnitude of voltage, or the magnitude of power supplied to the electronic devices with a predetermined reference value to determine the fastening state between the lid 120 and the main body 170.

In the present specification, the fastening state between the lid 120 and the main body 170 is classified as “normal” or “abnormal.”

In the present specification, the “normal” fastening state between the lid 120 and the main body 170 indicates a state in which the lid 120 and the main body 170 are completely fastened and the inner pot accommodation space 172 of the main body 170 is completely sealed by the lid 120, and thus cooking of food using the cooking appliance 100 is possible.

Conversely, the “abnormal” fastening state between the lid 120 and the main body 170 indicates a state in which the lid 120 and the main body 170 are not completely fastened and the inner pot accommodation space 172 of the main body 170 is not completely sealed by the lid 120, and thus cooking of food using the cooking appliance 100 is not possible.

For example, when the magnitude of current supplied from the power reception coils 504a and 504b is measured by a current sensor (not illustrated), the controller 200 compares the magnitude of current measured by the current sensor (not illustrated) with a predetermined reference current value. When the magnitude of current measured by the current sensor (not illustrated) is the reference current value or more, the controller 200 may determine the fastening state between the lid 120 and the main body 170 as “normal.” Conversely, when the magnitude of current measured by the current sensor (not illustrated) is less than the reference current value, the controller 200 may determine the fastening state between the lid 120 and the main body 170 as “abnormal.”

As another example, when the magnitude of voltage supplied from the power reception coils 504a and 504b is measured by a voltage sensor (not illustrated), the controller 200 compares the magnitude of voltage measured by the voltage sensor (not illustrated) with a predetermined reference voltage value. When the magnitude of voltage measured by the voltage sensor (not illustrated) is the reference voltage value or more, the controller 200 may determine the fastening state between the lid 120 and the main body 170 as “normal.” Conversely, when the magnitude of voltage measured by the voltage sensor (not illustrated) is less than the reference voltage value, the controller 200 may determine the fastening state between the lid 120 and the main body 170 as “abnormal.”

As still another example, the controller 200 calculates the magnitude of power supplied from the power reception coils 504a and 504b based on the magnitude of current and the magnitude of voltage supplied from the power reception coils 504a and 504b and compares the calculates magnitude of power with a predetermined reference power value. When the calculated magnitude of power is the reference power value or more, the controller 200 may determine the fastening state between the lid 120 and the main body 170 as “normal.” Conversely, when the calculated magnitude of power is less than the reference power value, the controller 200 may determine the fastening state between the lid 120 and the main body 170 as “abnormal.”

The communication module 204 is a device configured to wirelessly transmit or receive data or information according to control of the controller 200. In one embodiment of the present specification, the communication module 204 may wirelessly exchange data or information with other devices such as a power supply circuit 181 inside the main body 170 or a device other than the cooking appliance 100 (for example, an induction heating device 300).

The display module 204 is a device configured to display information related to driving of the cooking appliance 100. An example of the display module 204 may be a liquid crystal display, but the type of display module 204 is not limited thereto.

The controller 200, the communication module 204, and the display module 204 may each be implemented as a printed circuit board (PCB) having an integrated circuit (IC)-type chip embedded therein but is not limited thereto. Also, it should be understood that an electronic device other than the controller 200, the communication module 204, and the display module 204 may be further disposed in the lid storage space 118.

The solenoid valve 115 is driven by a control signal of the controller 200. The pressure inside the inner pot 130 is controlled as the solenoid valve 115 is opened and closed by control of the controller 200 in the cooking process.

Also, the lid 120 includes a first side surface portion 122 formed to be inclined in a direction from the lid cover 114 toward a lower surface of the lid 120 and a second side surface portion 124 extending in a direction from the first side surface portion 122 toward the lower surface of the lid 120.

The lid handles 116a and 116b configured to allow the user to lift the lid 120 are disposed on the first side surface portion 122. The lid handles 116a and 116b protrude in the radial direction from one side surface of the lid 120, for example, the first side surface portion 122. The positions, number, and shapes of the lid handles 116a and 116b may vary according to embodiments.

In one embodiment of the present specification, the lid 120 is completely detached from the main body 170. Therefore, when fastening the lid 120 to the main body 170 or detaching the lid 120 placed on the main body 170 from the main body 170, the user may easily lift the lid 120 using the lid handles 116a and 116b. Therefore, it becomes easy and convenient to move and store the lid 120. In particular, since temperature of the lid 120 increases in the cooking process, the user may lift the lid 120 using the lid handles 116a and 116b and thus not get burned.

The power reception coils 504a and 504b are disposed inside the lid handles 116a and 116b. The power reception coils 504a and 504b are disposed inside power reception coil accommodation spaces 810a and 810b formed inside the lid handles 116a and 116b. Since the lid handles 116a and 116b protrude in the radial direction from one side surface of the lid 120, the power reception coils 504a and 504b are also disposed at positions protruding in the radial direction from one side surface of the lid 120.

According to such arrangement, a distance R2 between a center 801 of a lower surface of the main body 170 (or the inner pot 130) and a center of each of the power reception coils 504a and 504b is greater than a radius R1 of the lower surface of the main body 170.

As described below, the power reception coils 504a and 504b generate current using a magnetic field generated by power transmission coils 502a and 502b.

The power reception coils 504a and 504b are electrically connected to the electronic devices disposed inside the lid storage space 118 of the lid 120, such as the controller 200, the communication module 204, and the display module 204. Therefore, current generated by the power reception coils 504a and 504b may be supplied to the electronic devices disposed inside the lid storage space 118, such as the controller 200, the communication module 204, and the display module 204.

In one embodiment of the present specification, a power conversion device (not illustrated) configured to convert alternating current power supplied by the power reception coils 504a and 504b into direct current power may be disposed in the lid storage space 118 of the lid 120. An electronic device driven by direct current power instead of the alternating current power supplied by the power reception coils 504a and 504b may be disposed inside the lid storage space 118 of the lid 120. For driving of such an electronic device, the power conversion device (not illustrated) configured to convert alternating current power into direct current power may be disposed.

In one embodiment of the present specification, the lid handles 116a and 116b may be made of a nonmetallic material. For example, the lid handles 116a and 116b may be made of a plastic material with low electrical conductivity and thermal conductivity. When current is generated by the power reception coils 504a and 504b, thermal energy is generated from the power reception coils 504a and 504b themselves. Therefore, when the lid handles 116a and 116b are made of a nonmetallic material, the user does not feel discomfort due to high temperature and is prevented from getting burned when holding the lid handles 116a and 116b.

Also, when wireless power transmission is performed by the power reception coils 504a and 504b, since the lid handles 116a and 116b are made of a nonmetallic material, power loss due to the lid handles 116a and 116b is minimized. Therefore, efficiency of the wireless power transmission performed by the power reception coils 504a and 504b is increased.

The inner pot 130 is a container configured to store food to be cooked or cooked food. The inner pot 130 has a shape that corresponds to the inner pot accommodation space 172 formed inside the main body 170. Since the inner pot 130 is heated by induction heating as described below, the inner pot 130 may be made of a magnetic metal material. For example, the material of the inner pot 130 may be cast iron containing an iron (Fe) component or a clad bonding iron (Fe), aluminum (Al), stainless steel, and the like but is not limited thereto.

A plurality of first fastening protrusions 148 are formed along a circumference of an end of the inner pot 130. When the lid 120 is rotated a predetermined angle after being coupled to an open upper surface of the main body 170 in a state in which the inner pot 130 is accommodated in the inner pot accommodation space 172, the first fastening protrusions 148 formed along the circumference of the end of the inner pot 130 are engaged with second fastening protrusions (not illustrated) formed on a fastening ring 126 disposed on the lower surface of the lid 120. By the first fastening protrusions 148 of the inner pot 130 and the second fastening protrusions (not illustrated) formed on the lower surface of the lid 120 being engaged with each other, the lid 120 is not detached from the main body 170, and thus the lid 120 and the main body 170 are completely fastened.

The main body 170 has a hollow cylindrical shape. The inner pot accommodation space 172 in which the inner pot 130 is accommodated is formed in an empty space inside the main body 170. One surface of the main body 170, for example, the upper surface thereof, is open, and one surface of the main body 170, for example, the lower surface thereof, is not open. Since the main body 170 has a cylindrical shape, the upper surface of the main body 170 and the lower surface of the main body 170 each have a circular cross-section.

Due to the main body 170 having a cylindrical shape, the cooking appliance 100 according to one embodiment of the present specification may be driven non-directionally. In the present specification, the cooking appliance 100 being driven non-directionally indicates that, in a state in which the main body 170 is placed on the induction heating device to drive the cooking appliance 100, the inner pot 130 can be heated by the induction heating device regardless of a direction that the outer surface of the main body 170 faces. The cooking appliance 100 according to the present specification has a cylindrical shape in which a front surface and a rear surface are not distinguished and a left side and a right side are not distinguished, unlike the conventional cooking appliance. Therefore, as long as the center of the lower surface of the cooking appliance 100 is close to the center of the heating area at an upper portion of the induction heating device, the inner pot 130 can be heated by the induction heating device regardless of the direction the outer surface of the main body 170 faces.

However, according to embodiments, the main body 170 may have a shape other than a cylindrical shape.

Also, in one embodiment of the present specification, the outer surface of the main body 170 may be made of a metal material. When the outer surface of the main body 170 is made of a metal material, it becomes convenient to clean foreign matter on the outer surface of the main body 170, and a phenomenon in which the outer surface of the main body 170 is contaminated or discolored due to other substances in the cleaning or cooking process can be prevented.

Also, when the outer surface of the main body 170 is made of a metal material, impact or vibration applied from the outside is reduced such that the components inside the main body 170 are more safely protected, and deformation of the main body 170 due to external impact, vibration, or temperature is prevented such that the durability of the cooking appliance 100 is improved.

Also, due to the outer surface of the main body 170 being made of a metal material, an aesthetic sense of the cooking appliance 100 is enhanced. In particular, when the lid cover 114 and the outer surface of the main body 170 are made of the same metal material, a sense of unity is formed between the lid 120 and the main body 170 when the lid 120 and the main body 170 are coupled, and thus the overall aesthetic sense of the cooking appliance 100 is enhanced.

Meanwhile, the cooking appliance 100 according to one embodiment of the present specification wirelessly receives power from the induction heating device. Therefore, in order to not affect the wireless power transmission from the induction heating device, the outer surface of the main body 170 may be made of a metal material in which an eddy current is not easily induced by a magnetic field. For example, the outer surface of the main body 170 may not include a magnetic material or may be made of a nonmagnetic metal material with very low magnetism.

Also, the lower surface of the main body 170 comes in contact with a bottom surface of a cooking space or an upper surface of the induction heating device in the cooking process. In particular, when the cooking appliance 100 is driven using the induction heating device, in order to facilitate power transmission between a working coil inside the induction heating device and a heating coil 182 or between the working coil inside the induction heating device and a power transmission coil 183, the lower surface of the main body 170 may be made of a nonmetallic material (for example, plastic).

In particular, when the cooking appliance 100 according to one embodiment of the present specification receives power from the induction heating device, power is supplied to the inside of the cooking appliance 100 through the lower surface of the main body 170 that comes in contact with the induction heating device. Therefore, the shape of the lower surface of the main body 170 being circular is beneficial for the power to be evenly transferred to the inside of the cooking appliance 100. Also, since the lower surface of the main body 170 is formed in a circular shape, when the cooking appliance 100 is placed on the induction heating device, power can be evenly transferred to the inside of the cooking appliance 100 regardless of a direction in which the cooking appliance 100 faces. Since the lower surface of the main body 170 is formed in a circular shape in this way, the cooking appliance 100 can be used non-directionally on the induction heating device.

As illustrated in FIG. 5, the power supply circuit 181, the heating coil 182, a power transfer coil 500, and a temperature sensor 184 are disposed in a main body storage space 850 formed inside the main body 170.

The cooking appliance 100 according to one embodiment of the present specification may be driven by power supplied from an external power supply.

The power supply circuit 181 converts power supplied from the external power supply and supplies high-frequency current to the heating coil 182. That is, in the embodiment illustrated in FIG. 5, the cooking appliance 100 may be connected via a wire to the external power supply and receive power from the external power supply.

When the high-frequency current is supplied to the heating coil 182, a magnetic field is generated in the heating coil 182. When an eddy current is induced in the inner pot 130 due to the magnetic field generated in the heating coil 182, Joule heat is generated in the inner pot 130 by a resistance component, eddy current loss, and hysteresis loss of the inner pot 130. Accordingly, the inner port 130 is heated.

Meanwhile, the cooking appliance 100 according to one embodiment of the present specification may receive power from a device other than the external power supply, such as the induction heating device 300, and perform a cooking or storing operation. That is, in the embodiment illustrated in FIG. 5, the cooking appliance 100 may receive power via a wire or wirelessly.

The power transfer coil 500 receives power from working coils 311 and 312 of the induction heating device 300. The power transfer coil 500 is electrically connected to the heating coil 182. While the cooking appliance 100 is placed on the induction heating device 300, when high-frequency current flows in the working coils 311 and 312, current is induced in the power transfer coil 500 due to a magnetic field generated in the working coils 311 and 312. The current induced in the power transfer coil 500 is supplied to the heating coil 182 electrically connected to the power transfer coil 500 and enables heating of the inner pot 130 by the heating coil 182.

Also, the power transfer coil 500 is electrically connected to the power transmission coils 502a and 502b. Therefore, the current generated by the power transfer coil 500 may be transferred to the power transmission coils 502a and 502b. When the current generated by the power transfer coil 500 is transferred to the power transmission coils 502a and 502b, as the current flows in the power transmission coils 502a and 502b, a magnetic field is generated around the power transmission coils 502a and 502b.

In this way, the cooking appliance 100 according to one embodiment of the present specification may be placed on the induction heating device 300 and receive power from the working coils 311 and 312. For the cooking appliance 100 to receive more power through the working coils 311 and 312, an area where the power transfer coil 500 and the working coils 311 and 312 overlap may be wider. Since most of the working coils 311 and 312 disposed inside the induction heating device 300 have a circular shape, an elliptical shape, or a quadrangular shape having a center, a transverse cross-section of the main body 170 and the power transfer coil 500 each having a circular shape is beneficial for the area where the power transfer coil 500 and the working coils 311 and 312 overlap to be maximized. Also, the transverse cross-section of the lid 120 also having a circular shape is beneficial for the inner pot accommodation space 172 inside the main body 170 having a circular shape to be completely sealed.

When the transverse cross-section of the main body 170 and the transverse cross-section of the lid 120 each have a circular shape in this way, it becomes easy for the user to match the center of the heating area in which the working coils 311 and 312 are disposed and the center of the cooking appliance 100 when placing the cooking appliance 100 on the induction heating device 300.

For reference, in the present specification, the transverse cross-section of the main body 170 and the transverse cross-section of the lid 120 each indicate a cross-section parallel to the bottom surface of the main body 170.

The temperature sensor 184 detects a temperature of a bottom surface of the inner pot 130 while the cooking appliance 100 is driven.

The inner pot accommodation space 172 configured to accommodate the inner pot 130 is formed in the main body 170. An outer end 140 is formed at an outer peripheral surface forming the outermost portion of the inner pot accommodation space 172.

Main body handles 171a and 171b configured to allow the user to lift the main body 170 are disposed on the outer end 140. The main body handles 171a and 171b protrude in the radial direction from one side of the main body 170, for example, the outer end 140. The positions, number, and shapes of the main body handles 171a and 171b may vary according to embodiments.

The cooking appliance 100 according to one embodiment of the present specification may wirelessly receive power through the induction heating device 300 instead of receiving power through a wired cable. Therefore, the user may be able to easily lift the main body 170 and place the main body 170 on the induction heating device 300 or easily lift the main body 170 placed on the induction heating device 300. According to one embodiment of the present specification, the user may easily lift the main body 170 using the main body handles 171a and 171b, and accordingly, convenience of the user and mobility of the cooking appliance 100 are increased, and storing the cooking appliance 100 becomes convenient. In particular, since the temperature of the main body 170 increases in the cooking process, the user may lift the main body 170 using the main body handles 171a and 171b and thus not get burned.

The power transmission coils 502a and 502b are disposed inside the main body handles 171a and 171b. The power transmission coils 502a and 502b are disposed inside power transmission coil accommodation spaces 812a and 812b formed inside the main body handles 171a and 171b. Since the main body handles 171a and 171b protrude in the radial direction from one side of the main body 170, the power transmission coils 502a and 502b are also disposed at positions protruding in the radial direction from one side of the main body 170.

According to such arrangement, a distance R2 between the center 801 of the lower surface of the main body 170 (or the inner pot 130) and the center of each of the power transmission coils 502a and 502b is greater than the radius R1 of the lower surface of the main body 170.

The power transmission coils 502a and 502b generate a magnetic field based on current supplied by the power transfer coil 500, thereby performing wireless power transmission for the power reception coils 504a and 504b.

In one embodiment of the present specification, the main body handles 171a and 171b may be made of a nonmetallic material. For example, the main body handles 171a and 171b may be made of a plastic material with low electrical conductivity and thermal conductivity. When current flows in the power transmission coils 502a and 502b and a magnetic field is generated, thermal energy is generated from the power transmission coils 502a and 502b themselves. Therefore, when the main body handles 171a and 171b are made of a nonmetallic material, the user does not feel discomfort when holding the main body handles 171a and 171b and is prevented from getting burned when holding the main body handles 171a and 171b.

Also, when wireless power transmission is performed by the power transmission coils 502a and 502b, since the main body handles 171a and 171b are made of a nonmetallic material, power loss due to the main body handles 171a and 171b is minimized. Therefore, efficiency of the wireless power transmission performed by the power transmission coils 502a and 502b is increased.

Power may be supplied to drive the electronic devices disposed inside the lid storage space 118 of the lid 120. However, the lid 120 according to one embodiment of the present specification is completely detached from the main body 170, and only the main body 170 directly receives power from the external power supply or the induction heating device. Therefore, power may be supplied from the main body 170 to the lid 120 to drive the electronic devices disposed inside the lid storage space 118.

As a method of supplying power from the main body 170 to the lid 120, placing an electrode for power transmission at each of one side of the main body 170 and one side of the lid 120 may be considered. However, when the electrode is disposed at each of the one side of the main body 170 and the one side of the lid 120, since the electrode may be exposed to the outside, there is a possibility that cleaning of the main body 170 and the lid 20 may become difficult, and contact between the electrodes may become defective due to foreign matter on the electrodes.

However, in one embodiment of the present specification, the power transmission coils 502a and 502b and the power reception coils 504a and 504b are disposed inside the main body handles 171a and 171b the lid handles 116a and 116b, respectively, and thus are not exposed to the outside. Therefore, it becomes easy to clean the main body 170 and the lid 120, and the probability of occurrence of failure is reduced such that the durability of the cooking appliance 100 is improved.

Also, each of a first inner step portion 142 formed to be stepped from the outer end 140 and a second inner step portion 144 formed to be stepped from the first inner step portion 142 are formed in the inner pot accommodation space 172.

As illustrated in FIG. 5, when the lid 120 is coupled to the main body 170, an end of the first side surface portion 122 of the lid 120 is supported by the first inner step portion 142. Also, when the lid 120 is coupled to the main body 170, a second fastening protrusion (not illustrated) formed on a fastening ring 126 of the lid 120 is engaged with the first fastening protrusion 148 on the second inner step portion 144.

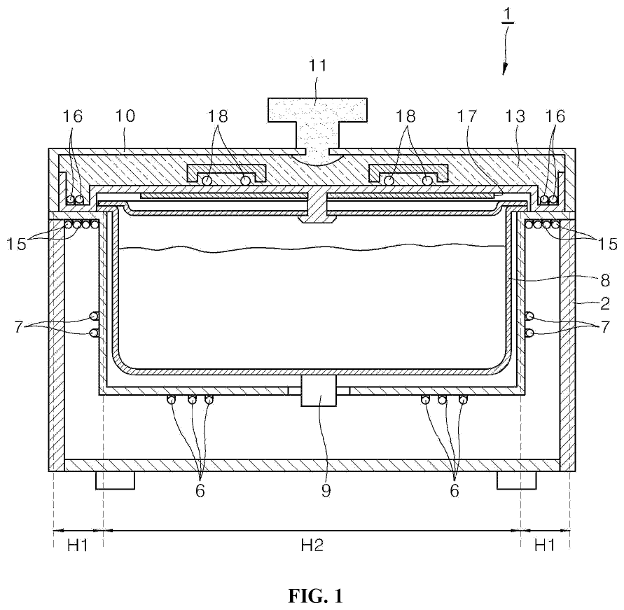

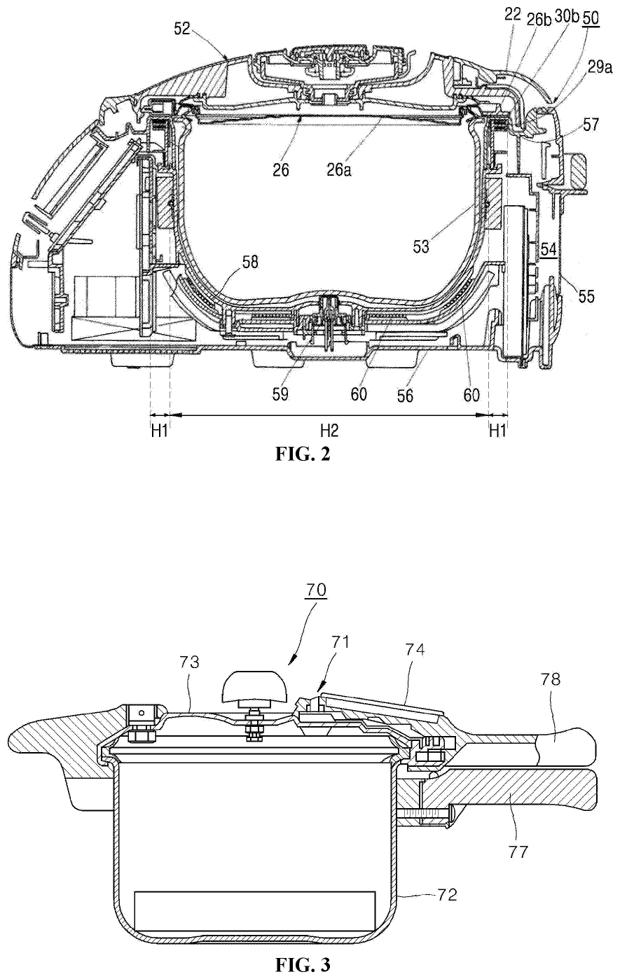

As illustrated in FIG. 5, in the cooking appliance 100 according to one embodiment of the present specification, the power transmission coils 502a and 502b configured to supply power to the electronic devices 200, 202, and 204 disposed inside the lid 120 are disposed inside the main body handles 171a and 171b instead of being disposed inside the main body 170. In other words, the power transmission coils 502a and 502b are not disposed inside the main body storage space 850. Therefore, it is not necessary to allocate a space for placing the power transmission coils 502a and 502b inside the outer end 140 of the main body 170 as in the conventional cooking appliance illustrated in FIG. 1. Thus, as illustrated in FIG. 5, a size H3 of the outer end 140 inside the main body 170 is reduced compared to the conventional case. When the size H3 of an inner space of the outer end 140 is reduced, a size H4 of the remaining space, excluding the outer end 140, of an inner space of the main body 170 increases. Therefore, since the size of the inner pot accommodation space 172 inside the main body 170 increases compared to the conventional case, the cooking capacity of the cooking appliance 100 is increased.

In particular, the cooking appliance 100 according to one embodiment of the present specification may be placed on the induction heating device 300 in order to receive power. However, the size of a lower surface of the induction heating device 300 and the size of the heating area formed on the induction heating device are each limited to a specific size. Therefore, the overall size (H3+H4+H3) of the cooking appliance 100 which should receive power through the induction heating device 300 is also limited to a specific size. In a situation in which the overall size (H3+H4+H3) of the cooking appliance 100 is limited in this way, the size H4 of the inner pot accommodation space 172 may increase with a decrease in the size H3 of the inner space of the outer end 140.

Consequently, according to an embodiment of the present specification, when the cooking appliance is assumed as having the same size as the conventional cooking device, since the size of the inner pot accommodation space is increased compared to the conventional cooking device, a larger capacity of food can be cooked or stored.

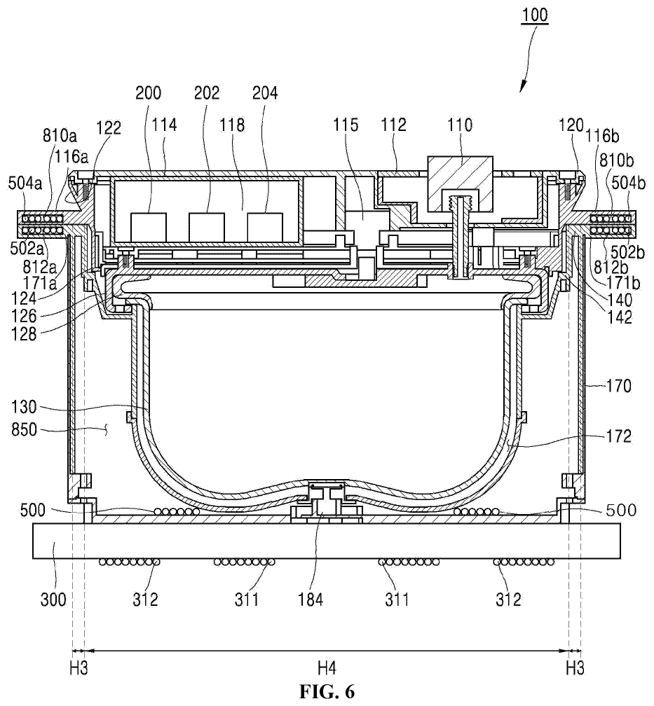

FIG. 6 is a cross-sectional view illustrating a state in which a lid, an inner pot, and a main body of a cooking appliance according to another embodiment of the present specification are coupled.

The configuration of a cooking appliance 100 illustrated in FIG. 6 is basically the same as the configuration of the cooking appliance 100 illustrated in FIG. 5. However, in an embodiment of FIG. 6, the cooking appliance 100 is not connected via a wire to an external power supply and only receives power wirelessly from an induction heating device 300. Accordingly, in the embodiment of FIG. 6, the power supply circuit 181 (see FIG. 5) configured to convert power supplied from the external power supply and supply high-frequency current to the heating coil 182 is not disposed in a main body storage space 850. Also, in the embodiment of FIG. 6, the heating coil 182 illustrated in FIG. 5 is not disposed in the main body storage space 850. Instead, in the embodiment of FIG. 6, only a power transfer coil 500 is disposed on a lower surface of the main body storage space 850. In the embodiment of FIG. 6, the power transfer coil 500 is disposed closer to the center of an inner pot 130 as compared to the embodiment of FIG. 5.

In the embodiment of FIG. 6, the power transfer coil 500 is induction-heated by working coils 311 and 312 of the induction heating device 300, and the inner pot 130 is heated by the power transfer coil 500. Also, although not illustrated, the power transfer coil 500 is electrically connected to a power transmission coil 502a and transfers current induced by the working coils 311 and 312 of the induction heating device 300 to the power transmission coil 502a.

In other words, in the embodiment of FIG. 6, the power transfer coil 500 transfers power to the power transmission coil 502a while heating the inner pot 130. Accordingly, since the heating coil 182 illustrated in FIG. 5 is omitted, parts constituting the cooking appliance 100 are simplified, and manufacturing costs are reduced.

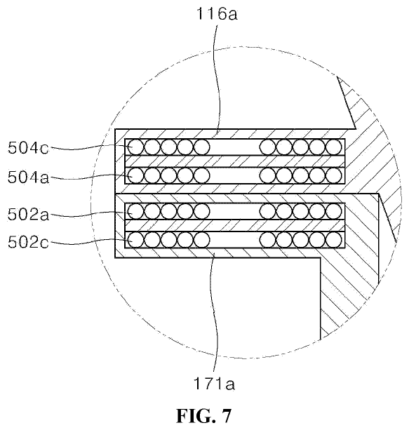

FIG. 7 illustrates an embodiment in which a wireless transmission coil disposed inside a main body handle and a wireless reception coil disposed inside a lid handle are each disposed in multiple layers.

In the embodiments of FIGS. 5 and 6, the power transmission coils 502a and 502b are disposed in a single layer inside the main body handles 171a and 171b, and the power reception coils 504a and 504b are disposed in a single layer inside the lid handles 116a and 116b.

However, in another embodiment of the present specification, the power transmission coils 502a and 502b disposed inside the main body handles 171a and 171b may be disposed in multiple layers, and the power reception coils 504a and 504b disposed inside the lid handles 116a and 116b may be disposed in multiple layers.

For example, as illustrated in FIG. 7, a first power transmission coil 502a and a second power transmission coil 502c disposed in a different layer from the first power transmission coil 502a may be disposed in a double layer inside the main body handle 171a. Also, a first power reception coil 504a and a second power reception coil 504c disposed in a different layer from the first power reception coil 504a may be disposed in a double layer inside the lid handle 116a.

An embodiment in which the power transmission coils and the power reception coils are disposed in double layers is illustrated in FIG. 7. However, in another embodiment of the present specification, the power transmission coils and the power reception coils may be configured in triple layers or more.

When the power transmission coils and the power reception coils are disposed in multiple layers as illustrated in FIG. 7, there is an advantage that the magnitude of power transmitted to the power reception coils by the power transmission coils is further increased.

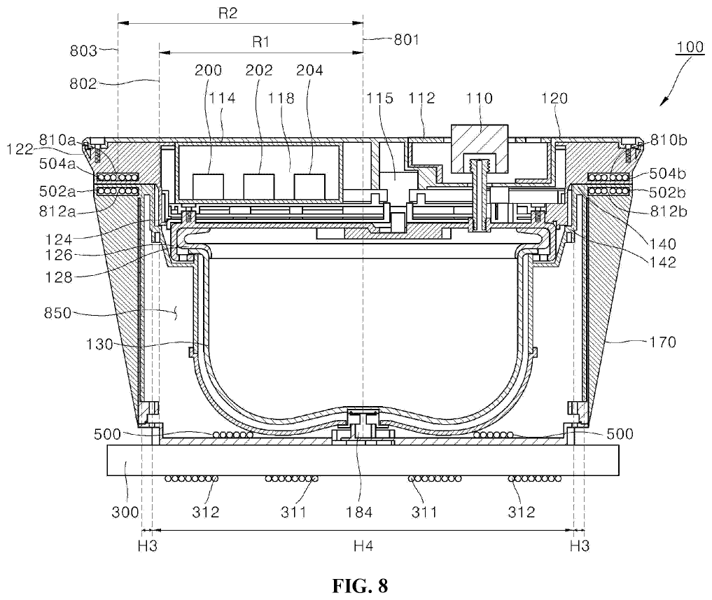

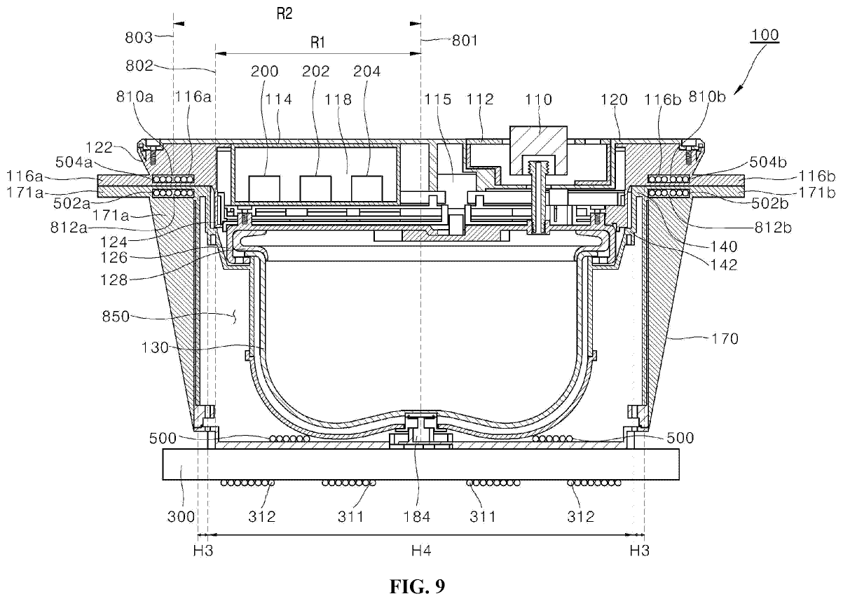

FIG. 8 is a cross-sectional view illustrating a state in which a lid, an inner pot, and a main body of a cooking appliance according to still another embodiment of the present specification are coupled. Also, FIG. 9 is a cross-sectional view illustrating a state in which a lid, an inner pot, and a main body of a cooking appliance according to yet another embodiment of the present specification are coupled.

The configurations of cooking appliances 100 illustrated in FIGS. 8 and 9 are basically the same as the configuration of the cooking appliance 100 illustrated in FIG. 6. However, while the main body 170 has a cylindrical shape in which a radius of a transverse cross-section is the same in an up-down direction in the embodiments of FIGS. 5 and 6, a main body 170 has a cylindrical shape in which a radius of a transverse cross-section progressively decreases from top to bottom of the main body 170 in the embodiments of FIGS. 8 and 9. In other words, a thickness of an outer surface of the main body 170 progressively increases from a lower surface of the main body 170 toward an upper surface thereof.

Also, in FIGS. 8 and 9, a radius of an outer peripheral surface of a lid 120 is equal to a radius of the upper surface of the main body 170.

In FIG. 8, power reception coil accommodation spaces 810a and 810b are formed inside an outer surface of the lid 120, and power transmission coil accommodation spaces 812a and 812b are formed inside the outer surface of the main body 170. The positions of the power reception coil accommodation spaces 810a and 810b and the positions of the power transmission coil accommodation spaces 812a and 812b correspond to each other. Accordingly, the positions of power reception coils 504a and 504b accommodated in the power reception coil accommodation spaces 810a and 810b and the positions of power transmission coils 502a and 502b accommodated in the power transmission coil accommodation spaces 812a and 812b correspond to each other.

Meanwhile, in the embodiment of FIG. 8, a lid handle is not disposed at one side of the lid 120, and a main body handle is not disposed at one side of the main body 170. However, as illustrated in FIG. 9, lid handles 116a and 116b protruding in one direction may be disposed at one side of the lid 120, and main body handles 171a and 171b protruding in one direction may be disposed at one side of the main body 170.

According to such arrangement, a distance R2 between the center 801 of the lower surface of the main body 170 (or the inner pot 130) and the center of each of the power reception coils 504a and 504b is greater than the radius R1 of the lower surface of the main body 170.

In the embodiments of FIGS. 8 and 9, the power transmission coils 502a and 502b are not disposed inside a main body storage space 850. Therefore, it is not necessary to allocate a space for placing the power transmission coils 502a and 502b inside the outer end 140 of the main body 170 as in the conventional cooking appliance illustrated in FIG. 1. Thus, as illustrated in FIG. 5, a size H3 of an inner space of the outer end 140 inside the main body 170 is reduced compared to the conventional case. When the size H3 of the inner space of the outer end 140 is reduced, a size H4 of the remaining space, excluding the outer end 140, of the inner space of the main body 170 increases. Therefore, since the size of the inner pot accommodation space 172 inside the main body 170 increases compared to the conventional case, the cooking capacity of the cooking appliance 100 is increased.

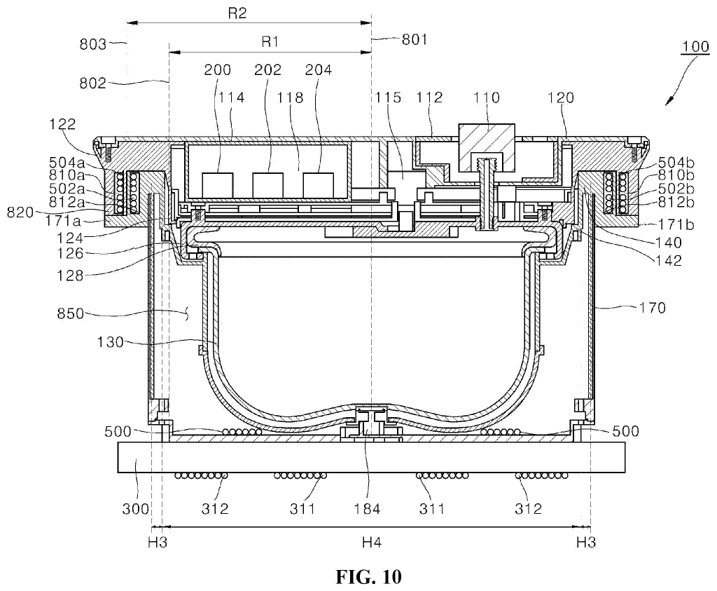

FIG. 10 is a cross-sectional view illustrating a state in which a lid, an inner pot, and a main body of a cooking appliance according to yet another embodiment of the present specification are coupled.

The configuration of a cooking appliance 100 illustrated in FIG. 10 is basically the same as the configuration of the cooking appliance 100 illustrated in FIG. 6.

In FIG. 10, a thickness of an outer end 140 of a main body 170 is formed thicker than the thickness of the outer end 140 of the main body 170 illustrated in FIG. 6. Also, main body handles 171a and 171b are disposed at a lower portion of the outer end 140. The main body handles 171a and 171b protrude in one direction from an outer surface of the main body 170.

Power transmission coil accommodation spaces 812a and 812b are formed inside the outer end 140. Power transmission coils 502a and 502b are disposed inside the power transmission coil accommodation spaces 812a and 812b.

Also, a lid coupling protrusion 820 is formed on an outer peripheral surface of a lid 120. The lid coupling protrusion 820 protrudes in a direction from the outer peripheral surface of the lid 120 toward a lower surface of the main body 170. An outer surface of the lid coupling protrusion 820 is connected to a first side surface portion 122. In other words, the lid coupling protrusion 820 is formed by the first side surface portion 122 extending from the outer peripheral surface of the lid 120.

When the lid 120 is coupled to an upper surface of the main body 170, an inner peripheral surface of the lid coupling protrusion 820 and an outer peripheral surface of the outer end 140 come in close contact with each other, and a lower end of the lid coupling protrusion 820 and upper surfaces of the main body handles 171a and 171b come in close contact with each other. Also, an upper surface of the outer end 140 and an inner surface of the lid 120 come in close contact with each other. Accordingly, an inner pot accommodation space 172 of the main body 170 is sealed by the lid 120.

Although not illustrated in FIG. 10, a length of a main body handle according to another embodiment of the present specification may be formed longer than the lengths of the main body handles 171a and 171b illustrated in FIG. 10. Accordingly, in a state in which the lid 120 is coupled to the upper surface of the main body 170, the user may lift the cooking appliance 100 using the main body handle.

Referring back to FIG. 10, power reception coil accommodation spaces 810a and 810b are formed inside the lid coupling protrusion 820, and the power transmission coil accommodation spaces 812a and 812b are formed inside the outer end 140. Power reception coils 504a and 504b are disposed inside the power reception coil accommodation spaces 810a and 810b, and the power transmission coils 502a and 502b are disposed inside the power transmission coil accommodation spaces 812a and 812b. The positions of the power reception coil accommodation spaces 810a and 810b and the positions of the power transmission coil accommodation spaces 812a and 812b correspond to each other. Accordingly, the positions of the power reception coils 504a and 504b accommodated in the power reception coil accommodation spaces 810a and 810b and the positions of the power transmission coils 502a and 502b accommodated in the power transmission coil accommodation spaces 812a and 812b correspond to each other.

In the embodiments of FIGS. 5, 6, 8, and 9, the power transmission coils 502a and 502b and the power reception coils 504a and 504b are each disposed parallel to the lower surface of the main body 170. However, in the embodiment of FIG. 10, the power transmission coils 502a and 502b and the power reception coils 504a and 504b are disposed in a direction perpendicular to the lower surface of the main body 170.

According to such arrangement, a distance R2 between the center 801 of the lower surface of the main body 170 (or the inner pot 130) and a contact surface between the inner peripheral surface of the lid coupling protrusion 820 and the outer peripheral surface of the outer end 140 is greater than the radius R1 of the lower surface of the main body 170. In another embodiment of the present specification, a distance between the center 801 of the lower surface of the main body 170 (or the inner pot 130) and the power transmission coils 502a and 502b, or a distance between the center 801 of the lower surface of the main body 170 (or the inner pot 130) and the power reception coils 504a and 504b, may be set to be greater than the radius R1 of the lower surface of the main body 170.

In the embodiment of FIG. 10, the power transmission coils 502a and 502b are not disposed inside a main body storage space 850. Therefore, it is not necessary to allocate a space for placing the power transmission coils 502a and 502b inside the outer end 140 of the main body 170 as in the conventional cooking appliance illustrated in FIG. 1. Thus, as illustrated in FIG. 10, a size H3 of an inner space of the outer end 140 inside the main body 170 is reduced compared to the conventional case. When the size H3 of the inner space of the outer end 140 is reduced, a size H4 of the remaining space, excluding the outer end 140, of the inner space of the main body 170 increases. Therefore, since the size of the inner pot accommodation space 172 inside the main body 170 increases compared to the conventional case, the cooking capacity of the cooking appliance 100 is increased.

Meanwhile, although not illustrated, a lid handle protruding in one direction may be disposed at one side of an outer peripheral surface of the lid coupling protrusion 820 of the lid 120 illustrated in FIG. 10.

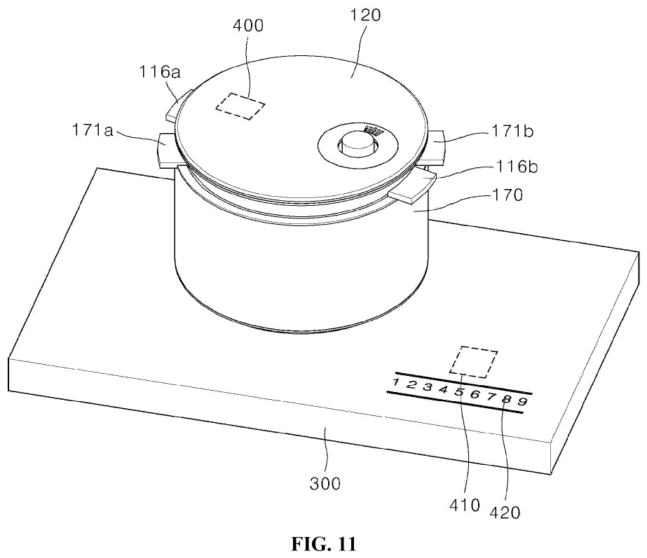

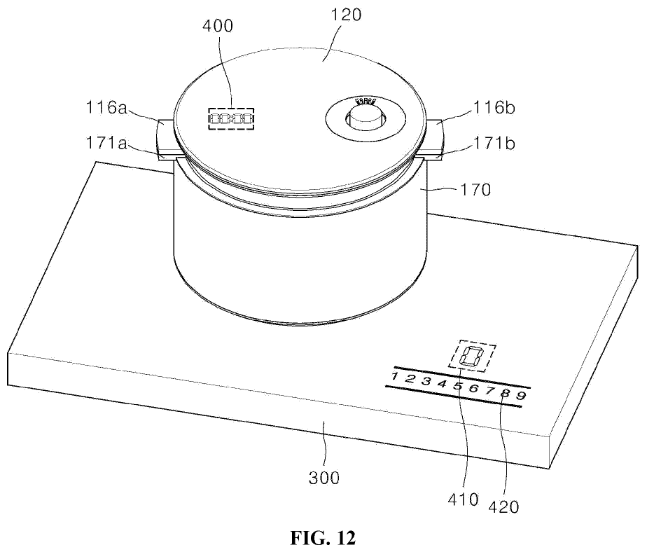

FIG. 11 illustrates a case in which a fastening state between a lid and a main body of a cooking appliance placed on an induction heating device is abnormal in one embodiment of the present specification. Also, FIG. 12 illustrates a case in which the fastening state between the lid and the main body of the cooking appliance placed on the induction heating device is normal in one embodiment of the present specification.

As illustrated in FIG. 11, a cooking appliance 100 according to one embodiment of the present specification may be heated by an induction heating device 300. As illustrated in FIG. 5 described above, working coils 311 and 312 may be disposed inside the induction heating device 300, and the cooking appliance 100 may be placed on the working coils 311 and 312.

A user who wants to cook food using the cooking appliance 100 places the cooking appliance 100 on the induction heating device 300 to which power is applied and puts an inner pot 130, which holds the food, in an inner pot accommodation space 172.

Then, the user couples a lid 120 to an open upper surface of a main body 170. As illustrated in FIG. 11, the user couples the lid 120 to the open upper surface of the main body 170 so that lid handles 116a and 116b of the lid 120 and main body handles 171a and 171b of the main body 170 do not coincide with each other, in other words, the lid handles 116a and 116b of the lid 120 and the main body handles 171a and 171b of the main body 170 do not overlap each other.

When the lid handles 116a and 116b of the lid 120 and the main body handles 171a and 171b of the main body 170 are disposed to not coincide with each other as illustrated in FIG. 11, wireless power transmission is not performed between power transmission coils disposed in the main body handles 171a and 171b and power reception coils disposed in the lid handles 116a and 116b. Therefore, power supply to electronic devices disposed inside the lid 120 is not performed.

Therefore, a controller 200 disposed inside the lid 120 is not able to determine a fastening state between the lid 120 and the main body 170. Also, since a display module disposed inside the lid 120 is not driven, as illustrated in FIG. 11, no information is displayed on a display window 400 of the lid 120.

Also, since the controller and a communication module are not driven, no information is delivered from the cooking appliance 100 to the induction heating device 300. Therefore, no information is displayed on a display window 410 of the induction heating device 300.

Consequently, when the lid 120 and the main body 170 are not completely fastened to each other as illustrated in FIG. 11, no information is displayed on the display window 400 of the lid 120 or the display window 410 of the induction heating device 300. Therefore, the user may easily recognize that the lid 120 and the main body 170 are not completely fastened to each other.

Meanwhile, when the user rotates the lid 120 in a predetermined direction in a state in which the lid 120 and the main body 170 are not completely fastened to each other as in FIG. 11, a first fastening protrusion 148 formed along a circumference of an end of the inner pot 130 and a second fastening protrusion formed on a fastening ring disposed on a lower surface of the lid 120 are engaged with each other, and thus, the lid 120 and the main body 170 are fastened.

As the main body handles 171a and 171b and the lid handles 116a and 116b begin to overlap each other due to rotation of the lid 120, power transmission coils 502a and 502b disposed in the main body handles 171a and 171b and power reception coils 504a and 504b disposed in the lid handles 116a and 116b begin to overlap each other. As the power transmission coils 502a and 502b and the power reception coils 504a and 504b begin to overlap, wireless power transmission between the power transmission coils 502a and 502b and the power reception coils 504a and 504b begins.

That is, as current flows in the working coils 311 and 312 disposed in the induction heating device 300, a magnetic field is generated around the working coils 311 and 312, and due to the magnetic field, current is induced in a power transfer coil 500 disposed at a lower portion inside the main body 170. As the current induced in the power transfer coil 500 flows in the power transmission coils 502a and 502b disposed in the main body handles 171a and 171b electrically connected to the power transfer coil 500, a magnetic field is generated around the power transmission coils 502a and 502b. Due to the magnetic field, current is induced in the power reception coils 504a and 504b disposed in the lid handles 116a and 116b. The current induced in the power reception coils 504a and 504b is supplied to the electronic devices disposed inside the lid 120.

Here, the magnitude of power supplied to the electronic devices disposed inside the lid 120 gradually increases with an increase in the size of an area where the lid handles 116a and 116b and the main body handles 171a and 171b overlap, in other words, an area where the power transmission coils 502a and 502b and the power reception coils 504a and 504b overlap. That is, the magnitude of power supplied to the electronic devices is proportional to the size of the area where the power transmission coils 502a and 502b and the power reception coils 504a and 504b overlap.

In the present specification, a gradual increase in the size of the area where the power transmission coils 502a and 502b and the power reception coils 504a and 504b overlap indicates a gradual decrease in a distance between a center of the power transmission coils 502a and 502b and a center of the power reception coils 504a and 504b. Therefore, the magnitude of power supplied to the electronic devices is inversely proportional to the distance between the center of the power transmission coils 502a and 502b and the center of the power reception coils 504a and 504b.

When the area where the power transmission coils 502a and 502b and the power reception coils 504a and 504b overlap is the maximum, in other words, the power transmission coils 502a and 502b and the power reception coils 504a and 504b completely overlap, the magnitude of power supplied to the electronic devices disposed inside the lid 120 becomes the maximum. In the present specification, a complete overlap between the power transmission coils 502a and 502b and the power reception coils 504a and 504b indicates coincidence between the center of the power transmission coils 502a and 502b and the center of the power reception coils 504a and 504b.

In one embodiment of the present specification, when the lid handles 116a and 116b and the main body handles 171a and 171b completely overlap each other, the power transmission coils 502a and 502b and the power reception coils 504a and 504b may completely overlap each other.

In one embodiment of the present specification, when the cooking appliance 100 is viewed vertically from above the lid 120, the size of the lid handles 116a and 116b and the size of the main body handles 171a and 171b may be set to be equal to each other. Therefore, when the lid handles 116a and 116b and the main body handles 171a and 171b completely overlap each other, when the cooking appliance 100 is viewed vertically from above the lid 120, the main body handles 171a and 171b may be completely covered by the lid handles 116a and 116b and not visible. The controller 200 which has received power from the power reception coils 504a and 504b determines the fastening state between the lid 120 and the main body 170.

In one embodiment of the present specification, the controller 200 may compare the magnitude of current, the magnitude of voltage, or the magnitude of power supplied to the electronic devices by the power reception coils 504a and 504b with a predetermined reference value to determine the fastening state between the lid 120 and the main body 170.

For example, when the magnitude of current supplied from the power reception coils 504a and 504b is measured by a current sensor (not illustrated), the controller 200 compares the magnitude of current measured by the current sensor (not illustrated) with a predetermined reference current value. When the magnitude of current measured by the current sensor (not illustrated) is the reference current value or more, the controller 200 may determine the fastening state between the lid 120 and the main body 170 as “normal.” Conversely, when the magnitude of current measured by the current sensor (not illustrated) is less than the reference current value, the controller 200 may determine the fastening state between the lid 120 and the main body 170 as “abnormal.”

As another example, when the magnitude of voltage supplied from the power reception coils 504a and 504b is measured by a voltage sensor (not illustrated), the controller 200 compares the magnitude of voltage measured by the voltage sensor (not illustrated) with a predetermined reference voltage value. When the magnitude of voltage measured by the voltage sensor (not illustrated) is the reference voltage value or more, the controller 200 may determine the fastening state between the lid 120 and the main body 170 as “normal.” Conversely, when the magnitude of voltage measured by the voltage sensor (not illustrated) is less than the reference voltage value, the controller 200 may determine the fastening state between the lid 120 and the main body 170 as “abnormal.”

As still another example, the controller 200 calculates the magnitude of power supplied from the power reception coils 504a and 504b based on the magnitude of current and the magnitude of voltage supplied from the power reception coils 504a and 504b and compares the calculated magnitude of power with a predetermined reference power value. When the calculated magnitude of power is the reference power value or more, the controller 200 may determine the fastening state between the lid 120 and the main body 170 as “normal.” Conversely, when the calculated magnitude of power is less than the reference power value, the controller 200 may determine the fastening state between the lid 120 and the main body 170 as “abnormal.” When wireless power transmission is not performed between the power transmission coils 502a and 502b and the power reception coils 504a and 504b, or the controller 200 determines the fastening state between the lid 120 and the main body 170 as abnormal, no information may be displayed on the display window 400 of the lid 120, or information indicating that fastening between the lid 120 and the main body 170 is abnormal (for example, “U”) may be displayed or flickered on the display window 400.

When the fastening state between the lid 120 and the main body 170 is determined as normal, the controller 200 controls the display module to display information indicating that fastening between the lid 120 and the main body 170 is done. Accordingly, information indicating that fastening between the lid 120 and the main body 170 is normal may be displayed on the display window 400 of the lid 120. For example, as illustrated in FIG. 12, “00:00” which is information indicating that fastening between the lid 120 and the main body 170 is normal is displayed or flickered continuously on the display window 400 of the lid 120.

Also, when wireless power transmission is not performed between the power transmission coils 502a and 502b and the power reception coils 504a and 504b, or the controller 200 determines the fastening state between the lid 120 and the main body 170 as abnormal, no information may be displayed on the display window 410 of the induction heating device 300, or information indicating that fastening between the lid 120 and the main body 170 is abnormal (for example, “U”) may be displayed or flickered on the display window 410.

Also, when the fastening state between the lid 120 and the main body 170 is determined as normal, the controller 200 sends information on the fastening state between the lid 120 and the main body 170, which is information indicating that fastening between the lid 120 and the main body 170 is normal, to another device, e.g., the induction heating device 300, through the communication module. Accordingly, the information indicating that fastening between the lid 120 and the main body 170 is normal may be displayed on the display window 410 of the induction heating device 300. For example, as illustrated in FIG. 12, “0” which is information indicating that fastening between the lid 120 and the main body 170 is normal is displayed or flickered continuously on the display window 410 of the induction heating device 300.

Consequently, the user can easily and intuitively recognize the fastening state between the lid 120 and the main body 170 through the display window 400 of the lid 120 or the display window 410 of the induction heating device 300. Accordingly, a situation in which the user attempts to cook in a state in which fastening between the lid 120 and the main body 170 is not done is prevented. Also, the user can easily and intuitively recognize that fastening between the lid 120 and the main body 170 is complete and food can be cooked using the cooking appliance 100. The user who has identified that the fastening state between the lid 120 and the main body 170 is normal may set a heating level of the cooking appliance 100 through an operation part 420 of the induction heating device 300 and input a heating command to drive the cooking appliance 100.

As described above, the cooking appliance 100 according to one embodiment of the present specification can determine the fastening state between the lid 120 and the main body 170 without including a separate device and can display the fastening state between the lid 120 and the main body 170. Therefore, the user can easily and intuitively identify whether the lid 120 and the main body 170 are completely fastened.

Also, according to one embodiment of the present specification, a separate device for determining the fastening state between the lid 120 and the main body 170 is not included in the cooking appliance 100. Therefore, there is an advantage that the manufacturing costs and size of the cooking appliance are reduced compared to the related art.

The embodiments of the present specification have been described above with reference to the accompanying drawings, but the present specification is not limited by the embodiments disclosed herein and the drawings, and it is apparent that various modifications may be made by those of ordinary skill in the art. Further, even when the effects according to configurations of the present specification are not explicitly described while describing the embodiments of the present specification, predictable effects of the corresponding configurations should also be recognized.

1. A cooking appliance comprising:
a main body defining an inner pot accommodation space therein;
an inner pot disposed in the inner pot accommodation space;
a lid coupled to one surface of the main body to seal the inner pot accommodation space the lid defining a storage space therein;
one or more electronic devices disposed in the storage space;
a power transmission coil disposed inside a main body handle that is provided at one side of the main body, the power transmission coil being configured to receive power transferred from an outside of the main body; and
a power reception coil disposed inside a lid handle that is provided at one side of the lid, the power reception coil being configured to receive power transmitted by the power transmission coil,
wherein the one or more electronic devices are configured to be driven by the power received by the power reception coil.

2. The cooking appliance of claim 1, wherein:
the lid is rotatably coupled to the main body; and
in a state in which the lid is coupled to the one surface of the main body to seal the inner pot accommodation space, the main body handle completely overlaps the lid handle.

3. The cooking appliance of claim 1, wherein the lid is a detachable lid that is completely detachable from the main body.

4. The cooking appliance of claim 1, wherein the main body handle and the lid handle are made of a nonmetallic material.

5. The cooking appliance of claim 1, wherein:
the main body handle protrudes in a radial direction from the one side of the main body; and
the lid handle protrudes in a radial direction from the one side of the lid.

6. The cooking appliance of claim 1, wherein a magnitude of power transferred to the one or more electronic devices is proportional to an area where the power transmission coil and the power reception coil overlap.

7. The cooking appliance of claim 1, further comprising a power conversion device disposed in the storage space, the power conversion device being configured to convert alternating current power supplied by the power reception coil into direct current power.

8. The cooking appliance of claim 1, further comprising:
a controller disposed in the storage space, the controller being configured to determine a fastening state between the lid and the main body,
wherein the controller is configured to determine the fastening state between the lid and the main body by comparing a magnitude of current, a magnitude of voltage, or a magnitude of power supplied to the one or more electronic devices by the power reception coil with a predetermined reference value.

9. The cooking appliance of claim 8, wherein the controller is configured to:
determine that the fastening state between the lid and the main body is normal based on the magnitude of current, the magnitude of voltage, or the magnitude of power being equal to or greater than the reference value; and
determine that the fastening state between the lid and the main body is abnormal based on the magnitude of current, the magnitude of voltage, or the magnitude of power being less than the reference value.

10. The cooking appliance of claim 8, wherein the controller is configured to (i) cause to be displayed information indicating the fastening state between the lid and the main body through a display module or (ii) send the information on the fastening state between the lid and the main body to another device through a communication module.

11. The cooking appliance of claim 1, further comprising a heating coil disposed inside the main body,
wherein the inner pot is configured to be heated by the heating coil.

12. The cooking appliance of claim 1, further comprising a power transfer coil disposed inside the main body and configured to transfer power transmitted from the outside to the power transmission coil.

13. The cooking appliance of claim 12, wherein the inner pot is configured to be heated by the power transfer coil.

14. The cooking appliance of claim 1, wherein a transverse cross-section of the main body and a transverse cross-section of the lid have a circular shape.

15. A cooking appliance comprising:
a main body defining an inner pot accommodation space therein;
an inner pot disposed in the inner pot accommodation space;
a lid coupled to one surface of the main body to seal the inner pot accommodation space the lid defining a storage space therein;
one or more electronic devices disposed in the storage space;
a power transmission coil disposed at a position protruding in a radial direction from one side of the main body and configured to receive power transferred from an outside of the main body; and
a power reception coil disposed at a position protruding in a radial direction from one side of the lid and configured to receive power transmitted by the power transmission coil,
wherein the one or more electronic devices are configured to be driven by the power received by the power reception coil.

16. The cooking appliance of claim 15, wherein:
the lid is rotatably coupled to the main body; and
in a state in which the lid is coupled to the one surface of the main body to seal the inner pot accommodation space, the power transmission coil and the power reception coil completely overlap each other.

17. The cooking appliance of claim 15, wherein the lid is a detachable lid that is completely detachable from the main body.

18. The cooking appliance of claim 15, wherein:
the power transmission coil is disposed inside a main body handle provided at one side of the main body; and
the power reception coil is disposed inside a lid handle provided at one side of the lid.

19. The cooking appliance of claim 18, wherein the main body handle and the lid handle are made of a nonmetallic material.

20. The cooking appliance of claim 15, wherein a magnitude of power transferred to the one or more electronic devices is proportional to an area where the power transmission coil and the power reception coil overlap.

21. The cooking appliance of claim 15, wherein a power conversion device configured to convert alternating current power supplied by the power reception coil into direct current power is disposed in the storage space.

22. The cooking appliance of claim 15, wherein:
a controller configured to determine a fastening state between the lid and the main body is disposed in the storage space; and
the controller is configured to determine the fastening state between the lid and the main body by comparing a magnitude of current, a magnitude of voltage, or a magnitude of power supplied to the one or more electronic devices by the power reception coil with a predetermined reference value.

23. The cooking appliance of claim 22, wherein the controller is configured to:
determine that the fastening state between the lid and the main body is normal based on the magnitude of current, the magnitude of voltage, or the magnitude of power being equal to or greater than the reference value; and
determine that the fastening state between the lid and the main body is abnormal based on the magnitude of current, the magnitude of voltage, or the magnitude of power being less than the reference value.

24. The cooking appliance of claim 22, wherein the controller is configured to (i) cause to be displayed information indicating the fastening state between the lid and the main body through a display module or (ii) send the information on the fastening state between the lid and the main body to another device through a communication module.

25. The cooking appliance of claim 15, further comprising a heating coil disposed inside the main body,
wherein the inner pot is configured to be heated by the heating coil.

26. The cooking appliance of claim 15, further comprising a power transfer coil disposed inside the main body and configured to transfer power transmitted from an outside to the power transmission coil.

27. The cooking appliance of claim 26, wherein the inner pot is configured to be heated by the power transfer coil.

28. The cooking appliance of claim 15, wherein a transverse cross-section of the main body and a transverse cross-section of the lid have a circular shape.

29. A cooking appliance comprising:
a main body defining an inner pot accommodation space therein;
an inner pot disposed in the inner pot accommodation space;
a lid that is coupled to one surface of the main body to seal the inner pot accommodation space and that defines a storage space therein to accommodate one or more electronic devices;
a power transmission coil disposed at one side of the main body and configured to receive power transferred from an outside of the main body; and
a power reception coil disposed at one side of the lid and configured to receive power transmitted by the power transmission coil,
wherein the inner pot is configured to be heated by power received by a power transfer coil,
wherein the one or more electronic devices are configured to be driven by the power received by the power reception coil,
wherein a distance between a center of a lower surface of the main body and a center of the power transmission coil is greater than a radius of the lower surface of the main body, and
wherein a distance between the center of the lower surface of the main body and a center of the power reception coil is greater than the radius of the lower surface of the main body.

30. The cooking appliance of claim 29, wherein:
the lid is rotatably coupled to the main body; and
in a state in which the lid is coupled to the one surface of the main body to seal the inner pot accommodation space, the power transmission coil and the power reception coil completely overlap each other.

31. The cooking appliance of claim 29, wherein the lid is a detachable lid that is completely detachable from the main body.

32. The cooking appliance of claim 29, wherein:
the power transmission coil is disposed inside a main body handle protruding in a radial direction from the one side of the main body; and
the power reception coil is disposed inside a lid handle protruding in a radial direction from the one side of the lid.

33. The cooking appliance of claim 32, wherein the main body handle and the lid handle are made of a nonmetallic material.

34. The cooking appliance of claim 29, wherein a magnitude of power transferred to the one or more electronic devices is proportional to an area where the power transmission coil and the power reception coil overlap.

35. The cooking appliance of claim 29, wherein a power conversion device configured to convert alternating current power supplied by the power reception coil into direct current power is disposed in the storage space.

36. The cooking appliance of claim 29, further comprising
a controller configured that is disposed in the storage space and configured to determine a fastening state between the lid and the main body,
the controller being configured to determine the fastening state between the lid and the main body by comparing a magnitude of current, a magnitude of voltage, or a magnitude of power supplied to the one or more electronic devices by the power reception coil with a predetermined reference value.

37. The cooking appliance of claim 36, wherein the controller is configured to:
determine that the fastening state between the lid and the main body is normal based on the magnitude of current, the magnitude of voltage, or the magnitude of being equal to or greater than the reference value; and
determine that the fastening state between the lid and the main body is abnormal based on the magnitude of current, the magnitude of voltage, or the magnitude of power being less than the reference value.

38. The cooking appliance of claim 36, wherein the controller is configured to (i) cause to be displayed information indicating the fastening state between the lid and the main body through a display module or (ii) send the information on the fastening state between the lid and the main body to another device through a communication module.

39. The cooking appliance of claim 29, further comprising a heating coil disposed inside the main body,
wherein the inner pot is configured to be heated by the heating coil.

40. The cooking appliance of claim 29, further comprising a power transfer coil disposed inside the main body and configured to transfer power transmitted from an outside to the power transmission coil.

41. The cooking appliance of claim 40, wherein the inner pot is configured to be heated by the power transfer coil.

42. The cooking appliance of claim 29, wherein a transverse cross-section of the main body and a transverse cross-section of the lid have a circular shape.
